(19) United States
(12) Patent Application Publication
(10) Pub. No.: US 2020/0172090 A1
(43) Pub. Date: Jun. 4, 2020

(54) APPARATUS AND METHOD OF CONTROLLING MOVEMENT OF DOUBLE-PARKED VEHICLE

(71) Applicants: HYUNDAI MOTOR COMPANY, Seoul (KR); KIA MOTORS CORPORATION, Seoul (KR)

(72) Inventor: Young Duk HAN, Suwon-si (KR)

(21) Appl. No.: 16/504,552

(22) Filed: Jul. 8, 2019

(30) Foreign Application Priority Data
Dec. 4, 2018 (KR) 10-2018-0154459

(51) Int. Cl. B60W 30/06; G06K 9/00; G06K 19/06; G06K 7/14; G06K 7/10

(52) U.S. Cl. CPC B60W 30/06; G06K 9/00791; G06K 19/06028; G06K 7/1413; B60R 11/04; G06K 2209/23; B60W 2420/42; B60W 2550/40; G06K 7/10722

(57) ABSTRACT

Disclosed is an apparatus and method of controlling movement of a double-parked vehicle, for autonomously moving a double-parked vehicle using a camera installed at a front/rear side of a vehicle even if a driver of a normal parked vehicle does not move the double-parked vehicle. The apparatus for controlling movement of a double-parked vehicle includes a camera configured to receive an image including code information, and a controller configured to control the vehicle to move the double-parked vehicle in a direction corresponding to code information in the image when the code information in the image received through the camera and prepared code information are identical with each other.

This application claims the benefit of Korean Patent Application No. 10-2018-0154459, filed on Dec. 4, 2018, which is hereby incorporated by reference as if fully set forth herein.

### BACKGROUND

### Field

The present disclosure relates to a vehicle, and more particularly, to an apparatus and method for controlling movement of a double-parked vehicle.

### Discussion of the Related Art

Recently, along with popularization of vehicle supply, double-park in which a vehicle is parked with a transmission in a neutral stage and a side brake or parking brake is released in order to allow the parked vehicle to be moved by a driver of another vehicle has become routine as a method for overcoming a problem in terms of a narrow parking space.

For example, when it is not possible to park a vehicle within a parking line of a parking lot and the vehicle is double-parked before or behind a vehicle that is parked already, a driver of another vehicle is capable of ensuring a space for moving his or her vehicle by pushing the double-parked vehicle in order to get out of the parking line.

Vehicles are frequently double-parked due to an insufficient parking space like in an apartment, a villa, and the like as well as a crowded place such as a shopping center or a department store.

### SUMMARY

In some instances of double-parking, when a driver of a normal parked vehicle wants to get out of a parking space by pushing a double-parked vehicle, if the driver of the normal parked vehicle is female, power for pushing and moving the double-parked vehicle is insufficient.

In view of foregoing, aspects of the present invention provide an apparatus and method of controlling movement of a double-parked vehicle.

Aspects of the present invention provide an apparatus and method of controlling movement of a double-parked vehicle, for autonomously moving a double-parked vehicle using a camera installed at a front/rear side of a vehicle even if a driver of a normal parked vehicle does not move the double-parked vehicle.

Additional advantages, aspects, and features of the invention will be set forth in part in the description which follows and in part will become apparent to those having ordinary skill in the art upon examination of the following or may be learned from practice of the invention. The other aspects and advantages of the invention may be realized and attained by the structure particularly pointed out in the written description and claims hereof as well as the appended drawings.

In one aspect of the invention, an apparatus for controlling movement of a double-parked vehicle includes a camera configured to receive an image including code information, and a controller configured to control the vehicle to move the double-parked vehicle in a direction corresponding to code information in the image when the code information in the image received through the camera and prepared code information are identical with each other.

The code information may include bar code information in which driver identification information of the vehicle is indicated, and the image may include an image formed by photographing a screen of an external mobile terminal, on which the code information is displayed.

The controller may control the vehicle to move in an opposite direction to a photograph direction of the camera.

The controller may control movement of the vehicle based on a change in a display size of the code information received through the camera.

The controller may control the vehicle to move when a display size of the code information received through the camera becomes larger than a reference display size, and may control the vehicle to stop when the display size of the code information received through the camera becomes smaller than the reference display size.

In another aspect of the present invention, a method of controlling movement of a double-parked vehicle includes receiving an image including code information by a camera installed in the double-parked vehicle, determining whether code information in the image received through the camera and prepared code information are identical with each other, and controlling the double-parked vehicle to move in a direction corresponding to code information in the image when the code information and the prepared code are identical with each other, as a result of the determining.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram showing the configuration of an apparatus for controlling movement of a double-parked vehicle according to one embodiment of the present invention;

FIG. 2 is a flowchart a procedure of controlling movement of a double-parked vehicle according to one embodiment of the present invention; and

FIGS. 3A, 3B, 4A and 4B are diagrams for explanation of a procedure of controlling movement of a double-parked vehicle according to one embodiment of the present invention.

### DETAILED DESCRIPTION OF EMBODIMENTS

Hereinafter, embodiments of the present invention are discussed in detail below with reference to the attached drawings. The same reference numerals in the drawings denote like elements, and a repeated explanation thereof will not be given. In the following description, the suffixes “module” and “unit” of elements herein are used for convenience of description and thus can be used interchangeably and do not have any distinguishable meanings or functions. Further, in the following description of embodiments, a detailed description of known functions and configurations incorporated herein will be omitted for the purpose of clarity and for brevity. The features of the present invention will be more clearly understood from the accompanying drawings and should not be limited by the accompanying drawings, and it is to be appreciated that all changes, equivalents, and substitutes that do not depart from the spirit and technical scope of the present invention are encompassed in the present invention.

It will be understood that, although the terms first, second, third etc. may be used herein to describe various elements, these elements should not be limited by these terms. These terms are only used to distinguish one element from another element.

It will be understood that when an element is referred to as being “connected to” or “coupled to” another element, it may be directly on, connected or coupled to the other element or intervening elements may be present. In contrast, when an element is referred to as being “directly on,” “directly connected to” or “directly coupled to” another element or layer, there are no intervening elements or layers present.

The singular expressions in the present specification include the plural expressions unless clearly specified otherwise in context.

It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

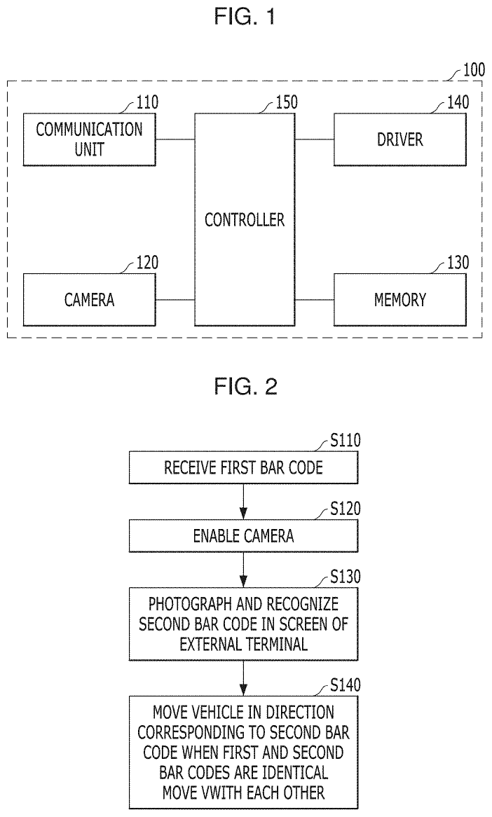

FIG. 1 is a block diagram showing the configuration of an apparatus for controlling movement of a double-parked vehicle according to one embodiment of the present invention.

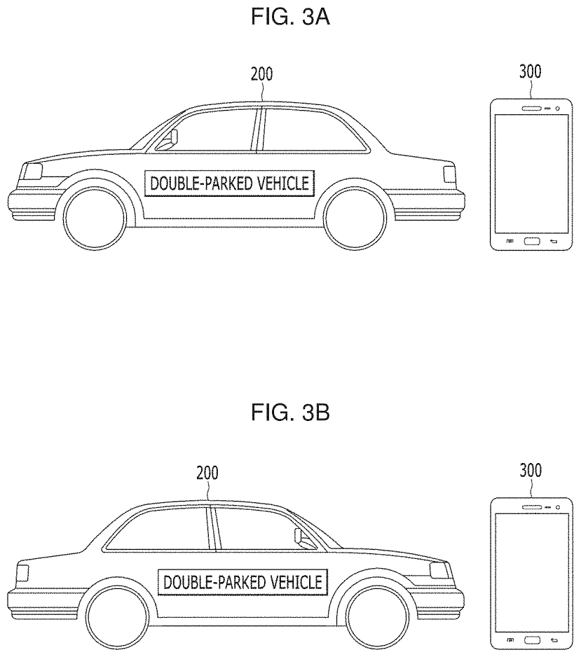

FIG. 2 is a flowchart a procedure of controlling movement of a double-parked vehicle according to one embodiment of the present invention.

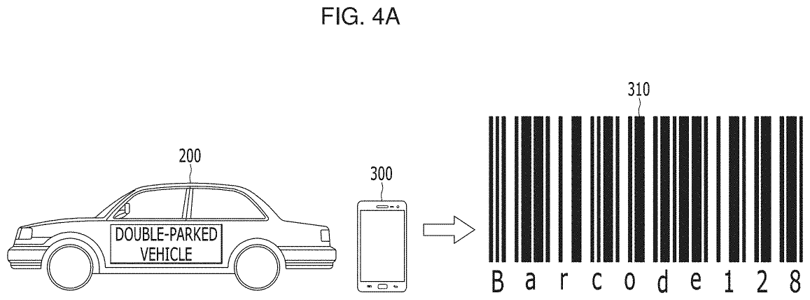

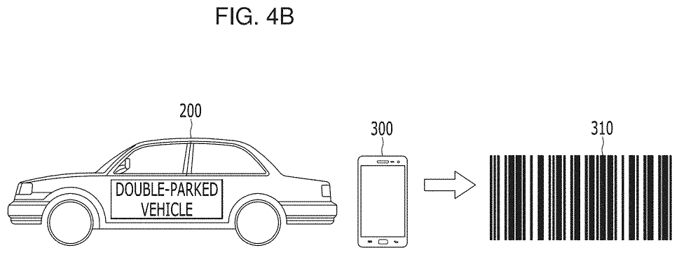

FIGS. 3A, 3B, 4A and 4B are diagrams for explanation of a procedure of controlling movement of a double-parked vehicle according to one embodiment of the present invention.

Referring to FIGS. 1 to 4B, an apparatus 100 for controlling movement of a double-parked vehicle according to embodiments of the present invention may include a communication unit 110, a camera 120, a memory 130, a driver 140, and a controller 150.

Hereinafter, a vehicle that is not capable of moving out in the case of a blocked access road due to a double-parked vehicle 200 will be referred to as a normal parked vehicle, and a mobile terminal owned by a driver of the normal parked vehicle will be referred to as a second terminal 300. In one instance, the normal parked car is parked in a lined parking space and blocked by a double-parked car. In another instance, the normal parked car may be a double-parked car that is blocked by another double-parked car.

The communication unit 110 may wirelessly communicate with a first terminal owned by a driver of the double-parked vehicle 200 corresponding to the present vehicle, and in particular, may receive a first bar code as code information including information identification information indicated therein of the double-parked vehicle 200, from the first terminal.

The aforementioned communication unit 110 may include at least one of a mobile communication module that performs mobile communication with the first terminal through mobile communication technology, a wireless Internet module that performs wireless Internet communication with the first terminal through wireless Internet technology, and a local area communication module that performs local-area communication with the first terminal through local area communication technology.

The mobile communication technology may include global system for mobile communication (GSM), code division multi access (CDMA), wideband CDMA (WCDMA), high speed downlink packet access (HSDPA), long term evolution (LTE), and 5^{th} generation (5G) mobile telecommunication.

The wireless Internet technology may include at least one of wireless LAN (WLAN), wireless fidelity (WiFi) direct, digital living network alliance (DLNA), wireless broadband (Wibro), world interoperability for microwave access (Wimax), high speed downlink packet access (HSDPA), and long term evolution (LTE).

The local area communication technology may include at least one of Bluetooth, radio frequency identification (RFID), infrared data association (IrDA), Ultra-Wideband (UWB), ZigBee, near field communication (NFC), wireless-fidelity (Wi-Fi), and Wi-Fi direct technologies.

The camera 120 may include a first camera that is installed on a front surface of the double-parked vehicle 200 and photographs a front side, and a second camera that is installed on a rear surface of the double-parked vehicle 200 and photographs a rear side.

The memory 130 may store various information items related to the double-parked vehicle 200 and may store a first bar code received through the communication unit 110 according to embodiments of the present invention.

In one embodiment, the driver 140 may turn on the double-parked vehicle 200 under the control of the controller 150, and when the double-parked vehicle 200 needs to be moved forward, the driver 140 may position a transmission in stage D to move the double-parked vehicle 200 forward under the control of the controller 150, may turn on an electronic parking brake (EPB) of the double-parked vehicle 200, which is currently moved forward, under the control of the controller 150, may re-turn off the EPB in an on-state to move the double-parked vehicle 200 forward again under the control of the controller 150, and may turn on the EPB of the double-parked vehicle 200, change a transmission to stage P from stage D, and then turn off the double-parked vehicle 200 under the control of the controller 150.

In another embodiment, the driver 140 may turn on the double-parked vehicle 200 under the control of the controller 150, and when the double-parked vehicle 200 needs to be moved backward, the driver 140 may position a transmission in stage R to move the double-parked vehicle 200 backward under the control of the controller 150, may turn on an electronic parking brake (EPB) of the double-parked vehicle 200, which is currently moved backward, under the control of the controller 150, may re-turn off the EPB in an on-state to move the double-parked vehicle 200 backward again under the control of the controller 150, and may turn on the EPB of the double-parked vehicle 200, change a transmission to stage P from stage R, and then turn off the double-parked vehicle 200 under the control of the controller 150.

The controller 150 may control overall operations of the double-parked vehicle 200 and the apparatus 100 for controlling movement of a double-parked vehicle according to embodiments of the present invention, and hereinafter, a procedure of controlling movement of a double-parked vehicle will be described in detail with reference to FIGS. 2 to 4B.

Referring to FIGS. 3A to 4B, when an access road of a normal parked vehicle is blocked by the double-parked vehicle 200 and call connection is performed between the second terminal 300 owned by a driver of the normal parked vehicle and a first terminal owned by a driver of the double-parked vehicle 200, the controller 150 may receive a first bar code from the first terminal through the communication unit 110 (S110).

In embodiments, the first terminal may transmit the first bar code to the communication unit 110, and simultaneously, may transmit a second bar code 310 that is the same as the first bar code, to the second terminal 300. In on embodiment, the second terminal 300 may display the received second bar code 310 on a screen.

The controller 150 may enable first and second cameras (front and rear cameras) to operate for a preset time period from a time point of receiving the first bar code (S120).

The controller 150 may determine whether the second bar code 310 displayed on the screen of the second terminal 300 is photographed and recognized, through any one of the first and second cameras.

In this case, when the second bar code 310 is not recognized through any one of the first and second cameras for the preset time period, the controller 150 may disable the first and second cameras.

When the second bar code 310 is photographed and recognized through any one of the first and second cameras for the preset time period (S130) and the received first bar code and the recognized second bar code 310 are identical with each other, the controller 150 may control the driver 140 to move the double-parked vehicle 200 in a corresponding to the second bar code 310 (S140).

In this case, when the second bar code 310 is photographed and recognized through any one of the first and second cameras, the controller 150 may control the driver 140 to move the double-parked vehicle 200 in an opposite direction to a photographing direction of the one corresponding camera.

For example, in FIG. 3A, when the second bar code 310 displayed on the screen of the second terminal 300 is photographed and recognized through the second camera that is the rear camera of the double-parked vehicle 200, the controller 150 may control the driver 140 to move the double-parked vehicle 200 forward in an opposite direction to a direction in which the second camera photographs a rear side.

In more detail, when the second bar code 310 displayed on the screen of the second terminal 300 is photographed and recognized through the second camera that is the rear camera, the controller 150 may control the driver 140 to turn on the double-parked vehicle 200, to position a transmission of the double-parked vehicle 200 in stage D, and to move the double-parked vehicle 200 forward.

In addition, when the second bar code 310 is not photographed and recognized through the second camera for the preset time period while the double-parked vehicle 200 is moved forward, the controller 150 may control the driver 140 to stop the double-parked vehicle 200 that is currently moved forward, to change the transmission to stage P from stage D, to turn on an electronic parking brake (EPB), and then to turn off the double-parked vehicle 200.

In addition, the controller 150 may maintain a state in which the double-parked vehicle 200 is currently moved forward or stop the double-parked vehicle 200 depending on a change in a display size of the second bar code 310 photographed through the camera, according to the procedure of FIGS. 4A and 4B.

In some instances, referring to FIG. 4A, when the display size of the second bar code 310 photographed through the second camera becomes larger than a preset reference display size, the controller 150 may control the driver 140 to maintain a state in which the double-parked vehicle 200 that is currently moved.

In this case, the reference display size may be a display size when the second camera is initially enabled to initially recognize the second bar code 310.

As shown in FIG. 4B, when the display size of the second bar code 310 photographed through the second camera becomes smaller than the preset reference display size, the controller 150 may control the driver 140 to turn on an electronic parking brake (EPB) and to stop the double-parked vehicle 200 that is currently moved forward, and when the display size of the second bar code 310 photographed through the second camera becomes larger than preset reference display size again, the controller 150 may control the driver 140 to turn off the EPB again and to move the double-parked vehicle 200, which is stopped, forward again.

However, when the display size of the second bar code 310 photographed through the second camera becomes smaller than the reference display size and this state is maintained for a preset time period or the second bar code 310 is not photographed and recognized through the second camera for the preset time period, the controller 150 may control the driver 140 to stop the double-parked vehicle 200 that is currently moved forward, to change a transmission to stage P from stage D, to turn on an electronic parking brake (EPB), and then to turn off the double-parked vehicle 200.

In FIG. 3B, when the second bar code 310 displayed on the screen of the second terminal 300 is photographed and recognized through the first camera that is the front camera of the double-parked vehicle 200, the controller 150 may control the driver 140 to move the double-parked vehicle 200 backward in an opposite direction to a direction in which the first camera photographs a front side.

In more detail, when the second bar code 310 displayed on a screen of the second terminal 300 is photographed and recognized by the first camera as a front camera, the controller 150 may control the driver 140 to turn on the double-parked vehicle 200 and to position a transmission of the double-parked vehicle 200 in stage R, and to move the double-parked vehicle 200 backward.

In addition, when the second bar code 310 is not photographed and recognized through the first camera during a preset time period while the double-parked vehicle 200 is moved backward, the controller 150 may control the driver 140 to stop the double-parked vehicle 200 that is currently moved backward, to change a transmission to stage P from stage R, to turn on an electronic parking brake (EPB), and then to turn off the double-parked vehicle 200.

As shown in the procedure of FIGS. 4A and 4B, the controller 150 may maintain or stop a forward state of the double-parked vehicle 200, that is currently moved backward, based on a change in a display size of the second bar code 310 photographed through the first camera.

In some instances, referring to FIG. 4A, when the display size of the second bar code 310 photographed through the first camera becomes larger than a preset reference display size, the controller 150 may control the driver 140 to maintain a backward state of the double-parked vehicle 200 that is currently moved backward.

In this case, the reference display size may be a display size when the first camera is initially enabled to initially recognize the second bar code 310.

As shown in FIG. 4B, when the display size of the second bar code 310 photographed through the first camera becomes smaller than the preset reference display size, the controller 150 may control the driver 140 to turn on an electronic parking brake (EPB) and to stop the double-parked vehicle 200 that is currently moved backward, and when the display size of the second bar code 310 photographed through the first camera becomes larger than preset reference display size again, the controller 150 may control the driver 140 to turn off the EPB again and to move the double-parked vehicle 200, which is stopped, backward.

However, when the display size of the second bar code 310 photographed through the first camera becomes smaller than the reference display size and this state is maintained for a preset time period or the second bar code 310 is not photographed and recognized through the first camera for the preset time period, the controller 150 may control the driver 140 to stop the double-parked vehicle 200 that is currently moved backward, to change a transmission to stage P from stage R, to turn on an electronic parking brake (EPB), and then to turn off the double-parked vehicle 200.

As described above, embodiments of the present invention are provided for the case in which it is difficult to move a normal parked vehicle due to the double-parked vehicle 200, or a female driver who has a difficulty in manually moving the double-parked vehicle 200, and even if the double-parked vehicle 200 is parked in stage N, when the double-parked vehicle 200 is a heavy vehicle and thus it is difficult to manually push the vehicle due to its high weight, the vehicle may include a system configured according to embodiments of the present invention and thus may be easily moved.

According to an embodiment of the present invention, when it is difficult to move a normal parked vehicle due to a double-parked vehicle, the double-parked vehicle may be advantageously and autonomously moved even if a driver of the normal parked vehicle does not push the double-parked vehicle.

It will be appreciated by persons skilled in the art that that the effects that could be achieved with the present invention are not limited to what has been particularly described hereinabove and other advantages of the present invention will be more clearly understood from the detailed description.

The terms used in the specification are defined in consideration of functions used in embodiments of the present invention, and can be changed according to the intent of technicians in this art or conventionally used methods. Accordingly, definitions of the terms should be understood on the basis of the entire description of the present specification.

It will be apparent to those skilled in the art that various modifications and variations can be made in the present invention without departing from the spirit or scope of the invention.

Thus, it is intended that the present invention cover the modifications and variations of this invention provided they come within the scope of the appended claims and their equivalents.

What is claimed is:

1. An apparatus for controlling movement of a double-parked vehicle, the apparatus comprising:
a camera configured to receive an image including code information; and
a controller configured to control the double-parked vehicle to move in a direction corresponding to the code information in the image when the code information in the image received through the camera and prepared code information are identical with each other.

2. The apparatus of claim 1, wherein the code information includes bar code information indicative of driver identification information of the double-parked vehicle.

3. The apparatus of claim 1, wherein the image includes an image formed by photographing a screen of an external mobile terminal, on which the code information is displayed.

4. The apparatus of claim 1, wherein the controller is configured to control the double-parked vehicle to move in an opposite direction to a photograph direction of the camera.

5. The apparatus of claim 1, wherein the controller controls movement of the double-parked vehicle according to a change in a display size of the code information received through the camera.

6. The apparatus of claim 5, wherein the controller is configured to control the double-parked vehicle to move when a display size of the code information received through the camera becomes larger than a reference display size, and further configured to control the double-parked vehicle to stop when the display size of the code information received through the camera becomes smaller than the reference display size.

7. A method of controlling movement of a double-parked vehicle, the method comprising:
receiving an image including code information by a camera installed in the double-parked vehicle;
determining whether code information in the image received through the camera and prepared code information are identical with each other; and
controlling the double-parked vehicle to move in a direction corresponding to code information in the image when the code information and the prepared code are identical with each other, as a result of the determining.

8. The method of claim 7, wherein the code information includes bar code information indicative of driver identification information of the double-parked vehicle.

9. The method of claim 7, wherein the image includes an image formed by photographing a screen of an external mobile terminal, on which the code information is displayed.

10. The method of claim 7, wherein the controlling includes controlling the double-parked vehicle to move in an opposite direction to a photograph direction of the camera.

11. The method of claim 7, wherein the controlling includes controlling movement of the double-parked vehicle based on a change in a display size of the code information received through the camera.

12. The method of claim 11, wherein the controlling includes controlling the double-parked vehicle to move when a display size of the code information received through the camera becomes larger than a reference display size, and controlling the double-parked vehicle to stop when the display size of the code information received through the camera becomes smaller than the reference display size.
